(19) United States
(12) Patent Application Publication
(10) Pub. No.: US 2024/0320035 A1
(43) Pub. Date: Sep. 26, 2024

(54) TASK ANALYSIS DEVICE AND OPERATING METHOD THEREOF

(71) Applicant: SAMSUNG ELECTRONICS CO., LTD., Suwon-si (KR)

(72) Inventors: Sangkyu Kim, Suwon-si (KR); Bumgyu Park, Suwon-si (KR); Sangil Park, Suwon-si (KR); Jonglae Park, Suwon-si (KR); Eunok Jo, Suwon-si (KR)

(73) Assignee: SAMSUNG ELECTRONICS CO., LTD., Suwon-si (KR)

(21) Appl. No.: 18/400,663

(22) Filed: Dec. 29, 2023

(30) Foreign Application Priority Data
Mar. 24, 2023 (KR) 10-2023-0039012
May 4, 2023 (KR) 10-2023-0058558

(51) Int. Cl. G06F 9/48; G06F 9/38

(52) U.S. Cl. CPC G06F 9/4881; G06F 9/3838

(57) ABSTRACT

A method to analyze tasks includes: obtaining, by a second device from a first device, log data including a plurality of log entries corresponding to a plurality of tasks executed in the first device; grouping the plurality of log entries into a plurality of groups based on at least one of task identifier information in each of the plurality of log entries and a type of each of the plurality of log entries; determining execution information and dependency information corresponding to each of the plurality of tasks, based on summing values extracted from log entries in each of the plurality of groups; and generating a task dependency graph indicating dependency information between the plurality of tasks and identifier information about each of the plurality of tasks, based on the execution information and the dependency information.

### CROSS-REFERENCE TO RELATED APPLICATIONS

This application is based on and claims priority under 35 U.S.C. § 119 to Korean Patent Application No. 10-2023-0039012, filed on Mar. 24, 2023, and Korean Patent Application No. 10-2023-0058558, filed on May 4, 2023, in the Korean Intellectual Property Office, the disclosures of which are incorporated herein by reference in their entirety.

### BACKGROUND

### 1. Field

The disclosure relates to a task analysis method, and more specifically, to a method of analyzing a dependency between a plurality of tasks.

### 2. Description of Related Art

A processor may perform various functions by executing instructions. The processor may include a plurality of processing cores for high performance, and each of the plurality of processing cores may independently execute instructions. A task including a series of instructions may be assigned to a processing core, and the processing core may sequentially execute assigned tasks. Information about relevance between the tasks may be an important index in analyzing the performance of a system executing tasks.

### SUMMARY

The present disclosure provides a method and device for analyzing and visualizing relational information between tasks.

According to an aspect of an example embodiment, a method to analyze tasks includes: obtaining, by a second device from a first device, log data including a plurality of log entries corresponding to a plurality of tasks executed in the first device: grouping the plurality of log entries into a plurality of groups based on at least one of task identifier information in each of the plurality of log entries and a type of each of the plurality of log entries: determining execution information and dependency information corresponding to each of the plurality of tasks, based on summing values extracted from log entries in each of the plurality of groups; and generating a task dependency graph indicating dependency information between the plurality of tasks and identifier information about each of the plurality of tasks, based on the execution information and the dependency information.

According to an aspect of an example embodiment, a device includes: a memory storing at least one instruction: at least one processor configured to execute the at least one instruction to: obtain, from a host device, log data including a plurality of log entries corresponding to a plurality of tasks executed in the host device, group the plurality of log entries into a plurality of groups based on at least one of task identifier information in each of the plurality of log entries and a type of each of the plurality of log entries, determine execution information and dependency information corresponding to each of the plurality of tasks, based on summing values extracted from log entries in each of the plurality of groups, and generate a task dependency graph indicating dependency information between the plurality of tasks and information about each task, based on the execution information and the dependency information.

According to an aspect of an example embodiment, a non-transitory computer readable medium for storing computer readable program code or instructions which are executable by a processor to perform a method including: obtaining, from a host device, log data including a plurality of log entries corresponding to a plurality of tasks executed by the host device: grouping the plurality of log entries into a plurality of groups based on at least one of task identifier information in each of the plurality of log entries and a type of each of the plurality of log entries: determining execution information and dependency information corresponding to each of the plurality of tasks, based on summing values extracted from log entries in each of the plurality of groups; and generating a task dependency graph indicating dependency information between the plurality of tasks and information about each of the plurality of tasks, based on the execution information and the dependency information.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a system according to one or more embodiments;

FIG. 2 is a block diagram illustrating a first processor of a first device according to one or more embodiments;

FIG. 3 is a block diagram illustrating a task analyzer according to one or more embodiments;

FIG. 4 is a table illustrating a structure of log data according to one or more embodiments;

FIG. 5 is a flowchart illustrating a method of analyzing task relevance information, according to one or more embodiments;

FIG. 6 is a flowchart illustrating an operating method of a second device, according to one or more embodiments;

FIGS. 7A and 7B are graphs illustrating task dependency graphs generated by a system according to one or more embodiments;

FIGS. 8A, 8B, and 8C are graphs illustrating a method of visualizing scheduling information of a specific task in a task dependency graph, according to one or more embodiments; and

FIG. 9 is a block diagram illustrating a system according to one or more embodiments.

### DETAILED DESCRIPTION

Hereinafter, embodiments of the disclosure will be described in detail with reference to the accompanying drawings. In the descriptions with reference to the drawings, the same or corresponding components are given the same reference numerals, and redundant descriptions thereof are omitted.

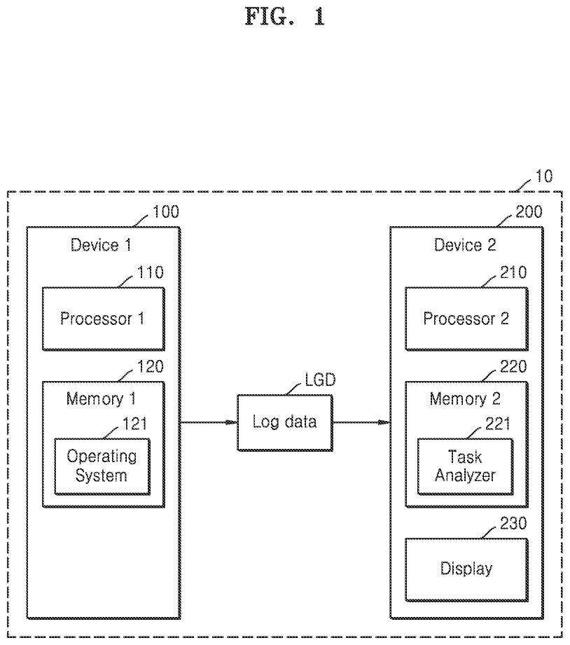

FIG. 1 is a block diagram illustrating a system 10 according to one or more embodiments.

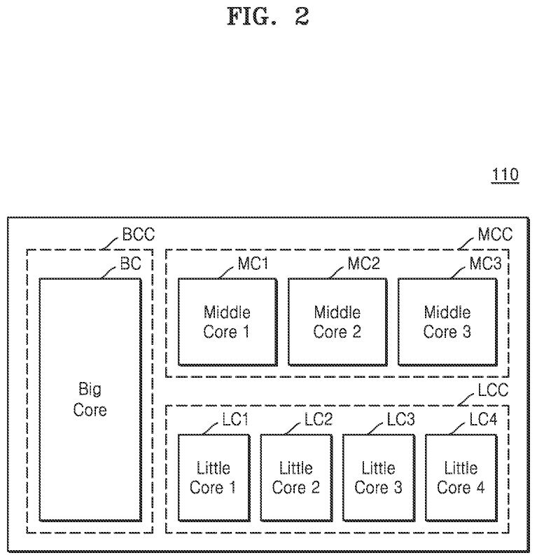

The system 10 may include a first device 100 and a second device 200. The first device 100 may include a first processor 110 and a first memory 120. The first processor 110 may execute codes related to an operating system 121 loaded on the first memory 120. A plurality of tasks may be executed on the operating system 121. The operating system 121 may schedule a plurality of tasks to be executed by the first processor 110. The first device 100 may be any system including a plurality of processing cores and a memory. For example, the first device 100 may be a computing system such as a personal computer, a mobile phone, a server, or the like, or may be a module in which a plurality of processing cores and a memory are mounted on a substrate as independent packages, and may be a system-on-chip (SoC) in which a plurality of processing cores and a memory are embedded into one chip. In an embodiment, the first device 100 may be referred to as a host, a host device, an external device, or a remote device. The first processor 110 may be any hardware capable of independently executing instructions, and may be referred to as a central processing unit (CPU), a processor core, a core, or the like. The first processor 110 may communicate with the first memory 120, and may execute instructions loaded in the first memory 120. The first processor 110 may include a plurality of cores or a plurality of clusters. The cores and clusters configuring the first processor 110 are described below with reference to FIG. 2.

Herein, a process may mean an application or a program, which is executed on the first processor 110. Each process may include a plurality of threads. A task may include a series of instructions, and a task may mean a thread. A thread may mean one process unit of a flow executed in a program operating in the first processor 110. In other words, a thread may mean one process unit of a flow executed in a process operating in the first processor 110.

Log data LGD may be a file in which a log generated by the first device 100 is recorded. In an embodiment, the log data LGD may be referred to as a log file or logging data. The log data LGD may be data generated in a process in which the first device 100 executes a plurality of tasks. The log data LGD may include a plurality of log entries. Each of log entries may mean a log corresponding to one process performed by any one a plurality of tasks. Each of log entries may include at least one of scheduling information about a plurality of tasks executed in the first device 100, information about interaction between the plurality of tasks, and microarchitectural information. Detailed description of the log data LGD is described below with reference to FIG. 2.

The second device 200 may be a system for executing a method of analyzing task relevance information, according to one or more embodiments. The second device 200 may analyze task relevance information and then visualize the analyzed result as a dependency graph and output the dependency graph to a display 230. In an embodiment, the first device 100 and the second device 200 may be communicatively coupled to each other in a development stage. The second device 200 may obtain the log data LGD from the first device 100.

The second device 200 may include a second processor 210, a second memory 220, and the display 230. The second device 200 may be any system including a plurality of processing cores and a memory. For example, the second device 200 may be a computing system such as a personal computer, a mobile phone, a server, or the like, or may be a module in which a plurality of processing cores and a memory are mounted on a substrate as independent packages, and may be an SoC in which a plurality of processing cores and a memory are embedded into one chip. The second processor 210 may be any hardware capable of independently executing instructions, and may be referred to as a CPU, a processor core, a core, or the like. The second processor 210 may communicate with the second memory 220, and may execute instructions loaded in the second memory 220.

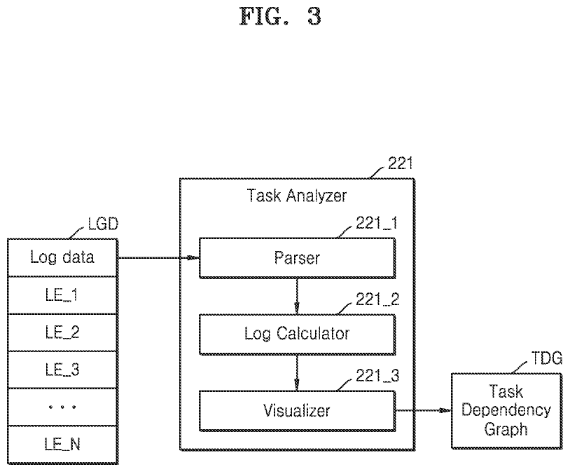

A task analyzer 221 may be loaded in the second memory 220. In an embodiment, the second device 200 may analyze the log data LGD obtained from the first device 100 by executing the task analyzer 221 loaded on the second memory 220. The second device 200 may generate a task dependency graph obtained by visualizing a result with respect to relevance information between tasks executed in the first device 100 through a result of analyzing the log data LGD. The second device 200 may provide a visualized task dependency graph to a user by outputting the generated dependency graph through the display 230. The task analyzer 221 may group pieces of log data LGD according to attributes of each of log entries. The task analyzer 221 may perform an operation of summing up attribute values of log entries for each group based on the grouped log data. Based on the result of summing up, the task analyzer 221 may generate a task dependency graph. Detailed description of the task analyzer 221 is described below with reference to FIG. 3.

The first memory 120 may be accessed by the first processor 110, and the second memory 220 may be accessed by the second processor 210. The first memory 120 may store software elements executable by the first processor 110. The second memory 220 may store software elements executable by the second processor 210. Non-limiting examples of a software element may include a software component, a program, an application, a computer program, an application program, a system program, a software development program, a machine program, operating system (OS) software, middleware, firmware, a software module, a routine, a subroutine, a function, a method, a procedure, a software interface, an application program interface (API), an instruction set, computing code, computer code, a code segment, a computer code segment, a word, a value, a symbol, or a combination of two or more thereof. In some embodiment, the first processor 110 may execute a program stored in the first memory 120, and the second processor 210 may execute a program stored in the second memory 220. A program may include a series of instructions.

The first memory 120 may store information, and may be any hardware accessible by the first processor 110. The second memory 220 may store information, and may be any hardware accessible by the second processor 210. For example, each of the first memory 120 and the second memory 220 may include read only memory (ROM), random-access memory (RAM), dynamic random access memory (DRAM), double-data-rate dynamic random access memory (DDR-DRAM), synchronous dynamic random access memory (SDRAM), static random access memory (SRAM), magnetoresistive random access memory (MRAM), programmable read only memory (PROM), erasable programmable read only memory (EPROM), electrically erasable programmable read only memory (EEPROM), flash memory, polymer memory, phase change memory, ferroelectric memory, silicon-oxide-nitride-oxide-silicon (SONOS) memory, a magnetic card/disk, an optical card/disk, or a combination of two or more thereof.

A task analysis method according to one or more embodiments may be stored in a non-transitory computer-readable storage medium. The term “computer-readable medium” may include any type of medium that may be accessed by a computer, such as ROM, RAM, a hard disk drive, a compact disc (CD), a digital video disc (DVD), or any other type of memory. A “non-transitory” computer-readable medium may exclude wired, wireless, optical or other communication links, which transmit transitory electrical or other signals, and may include a medium on which data is permanently stored and a medium on which data is stored and may be overwritten in the future, such as a rewritable optical disc or an erasable memory device.

FIG. 2 is a block diagram illustrating the first processor 110 of the first device 100 according to one or more embodiments. In particular, the block diagram of FIG. 2 may show a processing core system including heterogeneous processing cores. FIG. 2 may be described with reference to FIG. 1, and redundant descriptions may be omitted.

The first processor 110 may include processing cores respectively belonging to two or more core clusters. For example, the first processor 110 may include a big core cluster BCC, a middle core cluster MCC, and a little core cluster LCC. The big core cluster BCC may include a big core BC. The middle core cluster MCC may include a first middle core MC1, a second middle core MC2, and a third middle core MC3. The little core cluster LCC may include a first little core LC1, a second little core LC2, a third little core LC3, and a fourth little core LC4.

A processing core belonging to the big core cluster BCC, that is, the big core BC, may provide relatively high performance and power consumption. The big core BC may be referred to as a faster core. A processing core belonging to the little core cluster LCC, that is, the first little core LC1 to the fourth little core LC4, may provide relatively low performance and power consumption. A little core may be referred to as a slower core. The performance and power consumption provided by a processing core belonging to the middle core cluster MCC, that is, the first middle core MC1 to the third middle core MC3, may be lower than the performance and power consumption provided by a core belonging to the big core cluster BCC, and may be higher than the performance and power consumption provided by the cores belonging to the little core cluster LCC.

FIG. 2 shows that the big core cluster BCC includes one big core BC as an example, and the big core cluster BCC may include two or more big cores. Also, the middle core cluster MCC is shown as including three cores including the first middle core MC1 to the third middle core MC3 as an example, and may include fewer or more cores. Similarly, the little core cluster LCC is shown as including four cores including the first little core LC1 to the fourth little core LC4 as an example, and may include fewer or more cores. In some embodiments, the number of cores for each core cluster may be partly the same and partly different.

Tasks executed by the first device 100 (refer to FIG. 1) may be assigned to any one of cores included in the first processor 110 by a scheduler of the operating system 121, and may be executed by the assigned core. In a process of executing tasks in this way, a log related to a task may be generated, and may be referred to as a log entry.

In an embodiment, a task may have dependency relationships on one or more tasks. For example, a wakee task may be normally executed only when a waker signal from a waker task is included. That is, a waker task and a wakee take may be normally executed only when the waker task transmits a wakeup signal to the wakee task after the waker task is executed. When a wakee task is assigned to the big core BC of the big core cluster BCC, and a task related to waker task is assigned to the cores belonging to the little core cluster LCC, because an operating speed of the cores of the little core cluster LCC is relatively slow, a timing of executing the waker task may be delayed, and thus, even the wakee task is also assigned to the big core BC, the overall system speed and/or performance may be reduced because a wakeup signal is received late. Accordingly, to improve the performance of the overall system, tasks having relevance need to be assigned to the same core cluster. According to one or more embodiments, the relevance between tasks to be executed by the first device 100 may be analyzed through the task analyzer 221 (refer to FIG. 1). According to the analysis result, the dependency relationship between tasks may ne visualized through a dependency graph. A user (e.g., a developer) may optimize scheduling of tasks to be executed by the first device 100 by adjusting a scheduler based on the visualized information. Alternatively, based on the visualized information, the developer may design a new device having a configuration similar to the configuration of the first device 100. That is, the developer may use the visualized information as a design basis so that the new device may have high performance and low power consumption in processing a plurality of tasks.

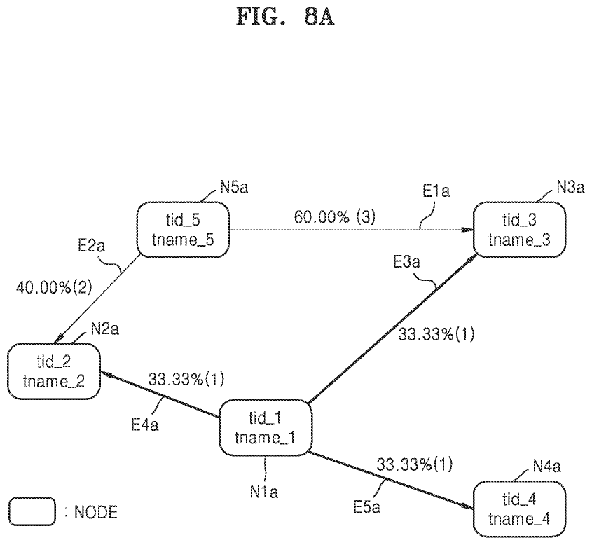

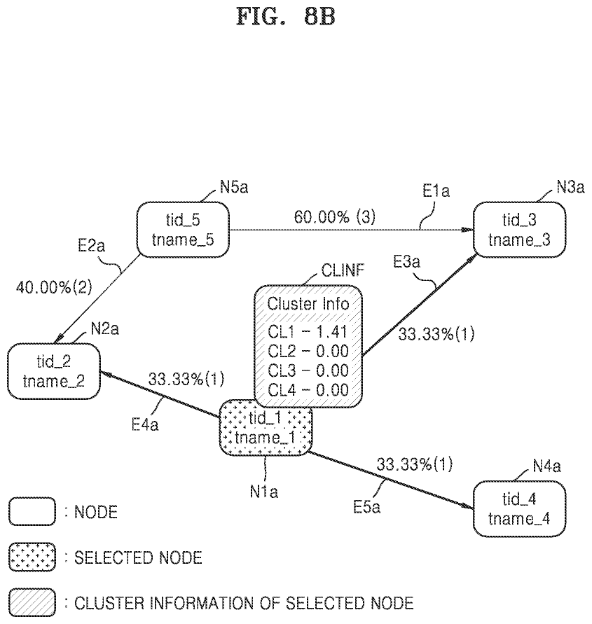

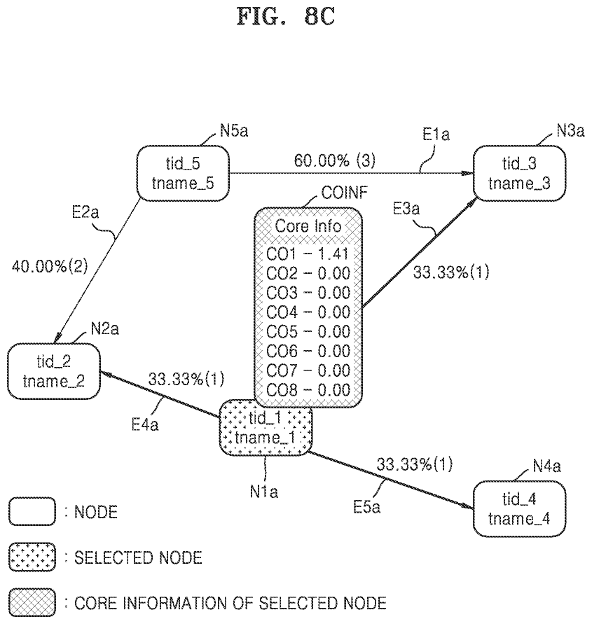

In an embodiment, a dependency graph may include core information such as information indicating a core to which each of tasks is assigned and the time of which the task is operated in the core. Similarly, a dependency graph may include cluster information indicating a cluster to which each of tasks is assigned and the time of which the task is operated in the core. A detailed description thereof is made below with reference to FIGS. 8A-8C.

FIG. 3 is a block diagram illustrating the task analyzer 221 according to one or more embodiments. FIG. 3 may be described with reference to FIG. 1, and redundant descriptions may be omitted.

Referring to FIG. 3, the second device 200 may obtain the log data LGD from the outside. For example, the second device 200 may obtain the log data LGD from the first device 100. The task analyzer 221 may analyze the obtained log data LGD. The task analyzer 221 may generate and output a task dependency graph TDG based on the analyzed result. The task analyzer 221 may include a parser 221_1, a log calculator 221_2, and a visualizer 221_3. The log data LGD may include a plurality of log entries. Each of the log entries may be a log related to tasks to be executed in the first device 100. In particular, the log data LGD may be a log file in which logs with respect to various tasks executed by the first processor 110 of the first device 100 are recorded. Accordingly, the plurality of log entries included in the log data LGD may be log entries with respect to various tasks executed by the first processor 110 of the first device 100. Multiple log entries may exist due to a particular task executed by the first processor 110. In an embodiment, the log data LGD may include a first log entry LE_1 to an N-th log entry LE_N (where N is a natural number greater than 1). For example, the first log entry LE_1 and a second log entry LE_2 may mean logs with respect to a first task, and the third log entry LE_3 to the fifth log entry LE_5 may mean logs with respect to a second task.

In an embodiment, each of the log entries belonging to the log data LGD may include both information about occurrence time (log occurrence time) of the log entry, and thread identifier information and process identifier information of a task corresponding to the log entry. Herein, the thread identifier information may be referred to as a thread ID, and the process identifier information may be referred to as a process ID.

The parser 221_1 may group log entries included in the log data LGD according to attributes of the log entries. In particular, the parser 221_1 may group log entries according to task identifier information corresponding to log entries and the type of information that log entries have. The task thread information may include thread identifier information and process identifier information. Also, the task identifier information may further include at least one of a thread name and a process name. The type of information that the log entries have may mean attributes of log entries, and in other words, may be referred to as a type of log information.

In an embodiment, each of the log entries may have at least one of scheduling information, interaction information, and microarchitectural information, which are attributes for each of a plurality of tasks. For example, the scheduling information may mean core information assigned to a task, execution time information of a task, and a context switching time of another task. In the case of log entries indicating scheduling information, the log entries may have some or all of the information listed above. For example, the interaction information may mean an identifier of a wakee task woken up by a waker task. For example, the microarchitectural information may refer to information about a type of instructions executed in a task. The type of instructions may be, for example, an integer type, a floating point type, a memory intensive type, or a core intensive type.

In an embodiment, the parser 221_1 may group log entries included in the log data LGD, that is, the first log entry LE_1 to the N-th log entry LE_N, based on process identifier information and thread identifier information. The parser 221_1 may group again the log entries of the log data LGD, which are grouped according to the process identifier information and the thread identifier information, according to the type of information that each log entry has. In particular, the log entries included in the log data LGD may be grouped by the process identifier information and the thread identifier information included in each of log entries, and the each group obtained by grouping in the above way may be subdivided and grouped according to the type of log entry. For example, it is assumed that a total of three task groups respectively corresponding to a first task, a second task, and a third task are formed in the log data LGD. Then, a first task group may be subdivided and grouped again into a first scheduling information group, a first interaction information group, and a first microachitectural group, which are subdivided groups with respect to the first task. Similarly, a second task group may be subdivided and grouped again into a second scheduling information group, a second interaction information group, and a second microachitectural group, which are subdivided groups with respect to the second task. Also, a third task group may be subdivided and grouped again into a third scheduling information group, a third interaction information group, and a third microarchitectural group, which are subdivided groups with respect to the third task.

After the grouping operation is completed, the parser 221_1 may sort group log entries according to a timeline for each group. That is, the parser 221_1 may sort log entries belonging to each group according to an order of occurrence time of each log entry. Herein, the parser 221_1 grouping the log data LGD may be referred to as parsing.

The log calculator 221_2 may analyze dependency between tasks for each group by using the log data LGD grouped by the parser 221_1. The log calculator 221_2 may be referred to as a log analyzer.

In the description of the task analyzer 221 of FIG. 3, for convenience of description, it is assumed that a group related to the first task exists among various groups included in the grouped log data LGD, and description is made by using the first task as an example. The group related to the first task may be referred to as a first task group. The first task group may be grouped based on identifier information of the first task, that is thread identifier information corresponding to the first task. The first task group may be grouped again into subdivided groups such as a scheduling information group, an interaction information group, and a microarchitectural information group.

Log entries belonging to the scheduling information group with respect to the first task may include execution information about the first task or context switching information from the first task to another task.

When a log entry belonging to a scheduling information group with respect to the first task includes execution information about the first task, the log calculator 221_2 may calculate a time taken to execute the first task by summing up values corresponding to information that log entries including execution information about the first task have. The visualizer 221_3 may visualize the time for which the first task has been executed in which core (or cluster) of the first device 100 through the value calculated by the log calculator 221_2. When a log entry belonging to the scheduling information group with respect to the first task includes context switching information about the first task, the log entry may include task identifier information about a task to be context-switched. For example, when a context switch to a second task occurs while the first task is being executed, a log entry occurred during such context switch may include identifier information of the second task.

Log entries belonging to an interaction information group with respect to the first task may include information about which task the first task transferred a wakeup signal to. In a process of executing a plurality of tasks on the first device 100, a certain task may normally operate only when a wakeup signal is received from a particular task. Due to the above reason, dependency information may be required to analyze dependency relationships between tasks. At this time, a task transferring a wakeup signal may be referred to as a waker task, and a task that receives a wakeup signal may be referred to as a wakee task. For example, when the first task transfers a wakeup signal to another task, the first task may be referred to as a waker task, and a task receiving a wakeup signal from the first task may be referred to as a wakee task.

The log calculator 221_2 may calculate information about dependencies between the first task and other tasks based on log entries belonging to an interaction information group of the first task. The information about dependencies may include at least one of a wakeup ratio between a waker task and a wakee task and a wakee count, and may also further include a waker count. Hereinafter, the information about dependencies may be referred to as dependency information.

Hereinafter, a value obtained by adding up the number of times of all wakeup signals transferred to wakee tasks by a waker task may be referred to as a waker count. For example, it is assumed that the first task is a waker task, and the second task and the third task are wakee tasks. When the first task transfers a wakeup signal three times to the second task and transfers the wakeup signal four times to the third task, the waker count of the first task may be 7. In an embodiment, the waker count may be calculated according information that log entries belonging to an interaction information group of a task group has and the number of log entries. For example, the first task is assumed as a waker task. Because a first task group is a group grouped based on an identifier of the first group, when the number of log entries belonging to the interaction information group in the first group is 10, the waker count of the first task may be 10.

Hereinafter, the number of wakeup signals that the wakee task receives from the waker task may be referred to as a wakee count. For example, it is assumed that the first task is a waker task, and the second task is a wakee task. When the second task receives 5 times of wakeup signals from the first task, the wakee count of the second task from the first task may be 5. In an embodiment, the wakee count may be calculated according to the number of log entries having the same wakee task identifier information among log entries belonging to the interaction information group of the task group. For example, it is assumed that the first task is a waker task, and the number of log entries belonging to the interaction information group in the first task group is 10. It is assumed that, among 10 log entries, 5 log entries have a value for an identifier of the second task as wakee task identifier information, 4 log entries have a value for an identifier of the third task as wakee task identifier information, and the remaining one has a value for an identifier of a fourth task as wakee task identifier. In this case, a wakee count calculated based on the wakeup signal received by the second task from the first task may be 5, a wakee count calculated based on the wakeup signal received by the third task from the first task may be 4, and a wakee count calculated based on the wakeup signal received by the fourth task from the first task may be 1.

A wakeup ratio between tasks may be calculated based on a waker count corresponding to the waker task and a wakee count between the waker task and the wakee task. In particular, the wakeup ratio may mean a ratio between the waker count and the wakee count. In an embodiment, the wakeup ratio may be expressed as a percentage. For example, it is assumed that a wakeup signal due to the first task, which is the waker task, is transferred to a total of three wakee tasks, that is, the second task, the third task, and the fourth task by one time each. Then, log entries belonging to the interaction information group of the first task may be 3. At this time, because the total wakeup signals due to the first task may be 3 times, and the three times of wakeup signals were respectively transferred to the second task, the third task, and the fourth task by once, the wakeup ratio of the first task to the second task may be 33.33%, the wake up ratio of the first task to the third task may be 33.33%, and the wakeup ratio of the first task to the fourth task may be 33.33%.

After calculating the wakeup ratio between tasks, the log calculator 221_2 may generate dependency information between tasks so that a value obtained by mapping the wakeup ratio and the wakee count value becomes dependency information between tasks. The visualizer 221_3 may visualize dependency information that the first task has one other tasks through the dependency information calculated by the log calculator 221_2. In an embodiment, when the dependency information is less than a reference value, the log calculator 221_2 may filter data related to a task that is not transferred to the visualizer 221_3. For example, when the reference value is 30%, in the case where a wakeup ratio between particular tasks is 30% or less, the log calculator 221_2 may filter information about such wakeup ratio, so that the information may not be transferred to the visualizer 221_3, and thus, the dependency information may not be displayed on a dependency graph. Such reference value may be a preset value stored in the second device 200, or may be a value input by a user.

Log entries belonging to a micro architectural information group of the first task may include information about a type of calculation performed in a process of executing the first task. For example, when an integer calculation is performed in executing the first task, the microarchitectural information that a log entry has may be a value indicating an integer type. When a floating-point calculation is performed in executing the first task, the microarchitectural information that a log entry has may be a floating-point type. When access to the first memory 120 is required to execute the first task, the microarchitectural information that a log entry has may be a value indicating a memory intensive type. When an access to the first memory 120 is not required and only register within the first processor 110 is used to execute the first task, the microarchitectural information that a log entry has may mean a core intensive type.

The log calculator 221_2 may collect log entries belonging to the microarchitectural information group of the first task group and analyze microarchitecture information mainly performed in the first task. For example, it is assumed that log entries belonging to the microarchitectural group of the first task is 5. Among the 5 log entries, when the microarchitectural information that 4 log entries have means an integer type and the microarchitectural information that one log entry has means a floating point type, the first task may mainly perform integer calculation.

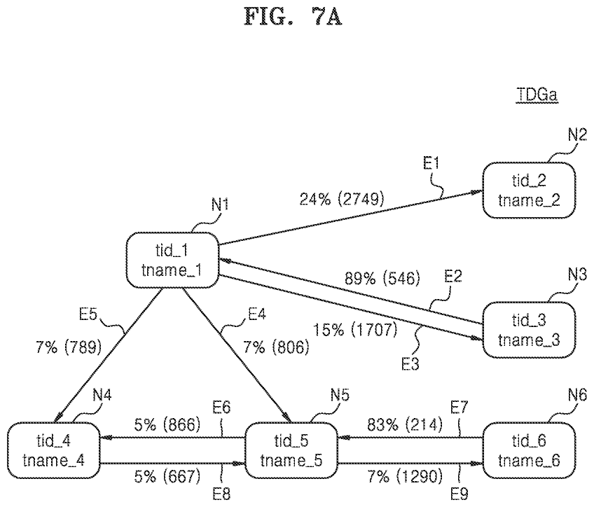

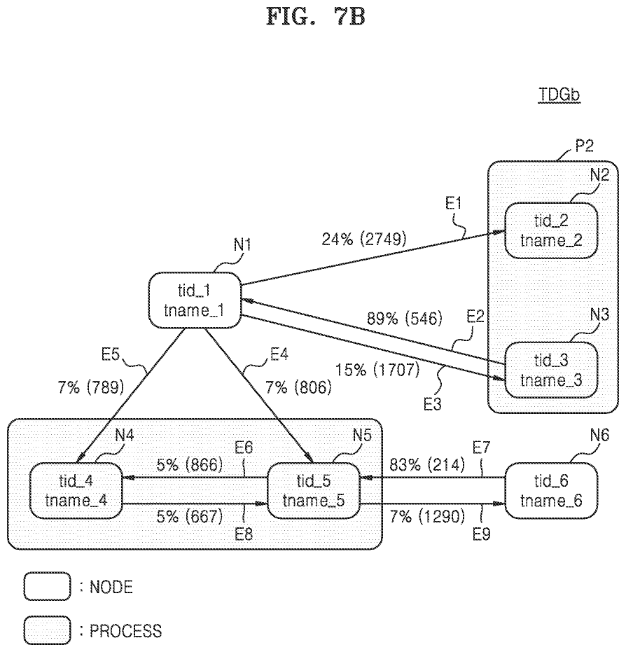

The visualizer 221_3 may receive the log data LGD including grouped log entries and dependency information between tasks from the log calculator 221_2. The visualizer 221_3 may generate the task dependency graph TDG based on the received information. The second device 200 may provide a user with a task dependency graph TDG obtained by visualizing the log data LGD by outputting the task dependency graph TDG generated by the visualizer 221_3 of the task analyzer 221 through the display 230. Information indicated by the task dependency graph TDG and a detailed description of a type of the task dependency graph TDG are described below with reference to FIGS. 7A to 8C.

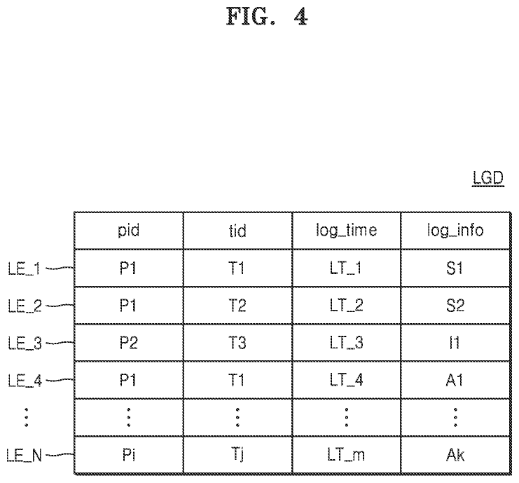

FIG. 0.4 is a table illustrating a structure of the log data LGD according to one or more embodiments. FIG. 4 may be described with reference to FIGS. 1 and 3, and redundant descriptions may be omitted.

Referring to FIG. 4, the log data LGD may include the first log entry LE_1 to the N-th log entry LE_N (where N is a natural number equal to or greater than 1). Each of log entries may include process identifier information pid, thread identifier information tid, occurrence time information log_time of a log entry, and log information log_info. Although the drawing shows that each log entry includes only one log information log_info, but this is an example, and one log entry may further include an additional log information log_info. Also, information that each of log entries has is an example for description, and each log entry may have other information.

In an embodiment, the process identifier information pid of the first log entry LE_1 may be a value indicating a first process P1, the thread identifier information tid may be a value indicating a first thread T1, and the occurrence time information log_time of each entry may be a value indicating a first time LT_1. The log information log_info that the first log entry LE_1 has may be a value indicating first scheduling information S1.

The second log entry LE_2 to the N-th log entry LE_N may also be configured similarly to the first log entry LE_1. However, the log information log_info that the third log entry LE_3 may mean first interaction information I1, the log information log_info that the fourth log entry LE_4 may mean first microarchitectural information A1. In the case of the N-th log entry LE_N, the process identifier information pid of the N-th log entry LE_N may be a value indicating an i-th process Pi (where i is a natural number equal to or greater than 1), the thread identifier information tid may be a value indicating a j-th thread (where j is a natural number equal to or greater than 1), the occurrence time information log_time of a log entry may be a value indicating m-th time LT_m (where m is a natural number equal to or greater than 1), and the log information log_info may be a value indicating k-th microarchitectural information Ak (where k is a natural number equal to or greater than 1).

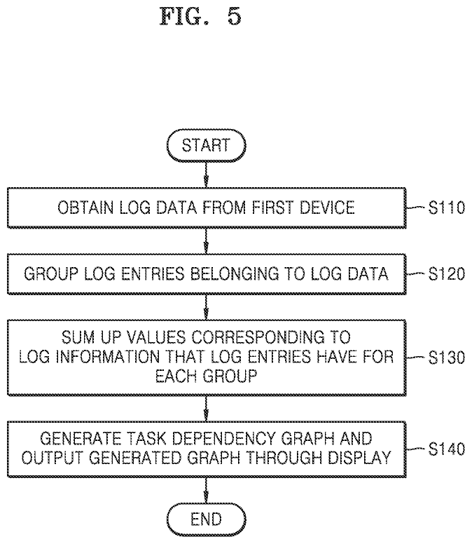

FIG. 5 is a flowchart illustrating a method of analyzing task relevance information, according to one or more embodiments. For example, FIG. 5 may be a flowchart illustrating an operating method of the second device 200 (refer to FIG. 1) analyzing the log data LGD (refer to FIG. 1) with respect to a plurality of tasks executed by the first device 100 (refer to FIG. 1). FIG. 5 may be described with reference to FIGS. 1 to 3, and redundant descriptions may be omitted.

In operation S110, the second device 200 may obtain, from the first device 100, the log data LGD with respect to a plurality of tasks, which includes log entries with respect to each of the plurality of tasks executed on the first device 100.

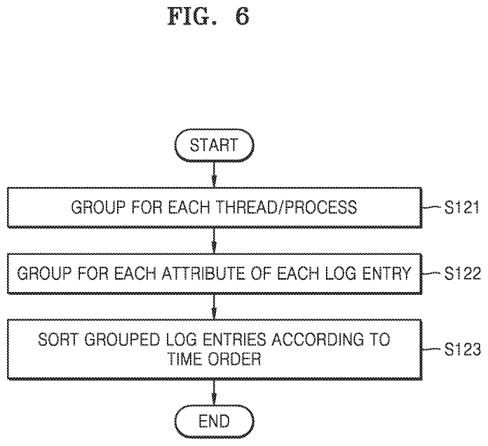

In operation S120, the second device 200 may group the log entries into a plurality of groups based on task identifier information corresponding to each of the log entries included in the log data LGD and the type of log information. Detailed operations related to operation S120 are described below with reference to FIG. 6.

In operation S130, the second device 200 may calculate execution information and dependency information for each task by summing up values corresponding to log information that the log entries have for each group.

In an embodiment, the second device 200 may calculate, for each of the plurality of groups grouped by thread identifier information and process identifier information, a waker count, which is the number of wakeup signals transferred by a waker task, based on the number of log entries including waker task identifier information.

In an embodiment, the second device 200 may calculate, for each of the plurality of groups grouped by the thread identifier information and process identifier information, a wakee count, which is the number of wakeup signals received by a wakee task from the waker task, based on wakee task identifier information included in the log entries.

In an embodiment, the second device 200 may calculate dependency information between the waker task and the wakee task based on the waker count and the wakee count. The dependency information may include at least one of a wakeup ratio and a wakee count.

In operation S140, the second device 200 may output the task dependency graph TDG through the display 230. In particular, the second device 200 may generate a task dependency graph indicating dependency information between the plurality of tasks and information about each task based on the execution information and dependency information of each task, and may provide a user with visualized analysis information about the plurality of tasks by outputting the task dependency graph with a display.

In an embodiment, the second device 200 may group each of nodes included in the task dependency graph based on the process identifier information. Accordingly, the user may confirm a relationship between a thread and a process. Detailed descriptions related thereto are made below with reference to FIGS. 7A and 7B.

In an embodiment, the second device 200 may output information about a selected node selected based on a user's input from among a plurality of nodes included in the task dependency graph TDG. At this time, the information about the selected node may include, for example, at least one of information about a core that processes a task corresponding to the selected node in the first device 100 and information about a cluster. Detailed descriptions related thereto are made below with respect to FIGS. 8A-8C.

FIG. 6 is a flowchart illustrating an operating method of the second device 200 according to one or more embodiments. For example, FIG. 6 may be a flowchart illustrating operation S120 of FIG. 5 in detail. FIG. 6 may be described with reference to FIGS. 1, 3, and 5, and redundant descriptions may be omitted.

In operation S121, the second device 200 may group log entries included in the log data LGD based on process identifier information and thread identifier information.

In operation S122, the second device 200 may group again the log entries of the log data LGD, which are grouped according to the process identifier information and the thread identifier information, according to the type of information that each log entry has. In other words, the log entries may be subdivided and grouped again according to attributes that each log entry has. In an embodiment, the second device 200 may group log entries based on wakee task identifier information.

In operation S123, the second device 200 may sort, for each group, the grouped log entries based on the time when each log entry was generated. That is, the second device 200 may sort, for each group, the grouped log entries according to a timeline.

FIGS. 7A and 7B are graphs illustrating task dependency graphs TDGa and TDGb generated by a system according to one or more embodiments. FIGS. 7A and 7B may be described with reference to FIGS. 1 and 3, and redundant descriptions may be omitted.

The graphs shown in FIGS. 7A and 7B may be graphs displayed on the display 230 (refer to FIG. 1) of the second device 200 (refer to FIG. 1). FIGS. 7A and 7B each showing 6 nodes and 9 edges are examples, and more or less nodes and edges may be displayed in a graph. Similarly, ratios and numbers shown to indicate information corresponding to each edge, that is, dependency information between tasks, are examples, and these numerical values may vary according to information included in the log data LGD (refer to FIG. 1).

Referring to FIG. 7A, the task dependency graph TDGa of FIG. 7A may correspond to the task dependency graph TDG of FIG. 3. The task dependency graph TDGa of FIG. 7A may be a graph generated based on the log data LGD received from the first device 100 (refer to FIG. 1). The task dependency graph TDGa may be a graph obtained by visualizing the relevance information about a plurality of tasks. The task dependency graph TDGa may include a plurality of nodes (that is, first to sixth nodes N1 to N6) and a plurality of edges E1 to E9 (that is, first to ninth edges E1 to E9).

In the task dependency graph TDGa, one node may correspond to a particular task operated in the first device 100. The plurality of nodes included in the task dependency graph TDGa may respectively correspond to a plurality of tasks executed on the first device 100. Accordingly, the first node N1 to the sixth node N6 in FIGS. 7A and 7B may respectively correspond to a first task to a sixth task, which are executed on the first device 100. Through the plurality of nodes included in the task dependency graph TDGa, the second device 200 may visualize and show task identifier information corresponding to each node. For example, the first node N1 may indicate a thread identifier tid_1 and a thread name tname_1 with respect to a first task corresponding to the first node N1. The second node N2 to the sixth node N6 may indicate thread identifiers and thread names with respect to tasks corresponding to respective nodes, similarly to the first node N1.

In the task dependency graph TDGa, one edge may be visualized as a line connecting one node to another node. Dependency information between tasks may be mapped to each edge, and may be visualized by indicating information about the dependency as a numerical value. Through the plurality of edges included in the task dependency graph TDGa, the second device 200 may visualize and show dependency information between the plurality of tasks. An arrow direction of each of edges may mean a transfer direction of a wakeup signal. For example, because the first edge E1 is configured in a direction pointing to the second node N2 from the first node N1, this may mean that a first task corresponding to the first node N1 transfers a wakeup signal to a second task corresponding to the second node N2. Similarly, because the second edge E2 is configured in a direction in which the third node N3 points to the first node N1, this may mean that a third task corresponding to the third node N3 transfers a wakeup signal to the first task corresponding to the first node N1.

In an embodiment, the first edge E1 may show dependency information that the first task corresponding to the first node N1 has with respect to the second task corresponding to the second node N2. When the first task transfers a wakeup signal to the second task, the first task may be a waker task, and the second task may be a wakee task. Because the second task may normally operate only when receiving a wakeup signal from the first task, dependency information that the second task has with respect to the first task may be visualized through the first edge E1. The dependency information indicated by the first edge E1 may include a wakee count, which is the number of wakeup signals received by the second task from the first task. For example, the dependency information may include that the second task received a total of 2749 times of wakeup signals from the first task. Also, the dependency information indicated by the first edge E1 may include a wakeup ratio of the first ratio to the second task. For example, the fact that the second task received 2749 times of wakeup signals from the first task means that the first task transferred 2749 times of wakeup signals to the second task in other words. Accordingly, the dependency information may include that the number of wakeup signals transferred from the first task to the second task accounts for a ratio of 24% of a waker count, which is the total number of wakeup signals transferred from the first task to other tasks including the second task. The second edge E2 to the ninth edge E9 may also indicate dependency information between tasks corresponding to respective nodes in a structure similar to that of the first edge E1.

In an embodiment, a larger number of edges than the edges shown in FIGS. 7A and 7B may be connected to each node. Edges not shown may not appear because there is no dependency relationship between tasks, or may not appear because a filtering operation based on a wakeup ratio and a reference value is performed.

Referring to FIG. 7B, the task dependency graph TDGb of FIG. 7B may correspond to the task dependency graph TDGa of FIG. 7A. The task dependency graph TDGb of FIG. 7B may be a graph obtained by additionally visualizing the relationship between a process and a thread in the task dependency graph TDGa of FIG. 7A.

In the task dependency graph TDGb of FIG. 7B, when the second device 200 generates the task dependency graph TDGb and then output the same to a display, respective nodes included in the task dependency graph TDGb may be grouped based on the process identifier information. That is, the second device 200 may provide a user with easily visualized data by grouping threads belonging to the same process.

In an embodiment, a fourth task corresponding to the fourth node N4 and a fifth task corresponding to the fifth task N5 may belong to the first process P1. The second device 200 may group the fourth node N4 and the fifth node N5 by performing a grouping operation based on the identifier information of the first process P1 and display the same as shown in FIG. 7B. Similarly, the second task corresponding to the second node N2 and the third task corresponding to the third node N3 may belong to a second process P2. The second device 200 may group the second node N2 and the third node N3 by performing a grouping operation based on the identifier information of the second process P2 and display the same as shown in FIG. 7B.

FIGS. 8A-8C are graphs illustrating a method of visualizing scheduling information of a specific task in a task dependency graph, according to one or more embodiments. The number of nodes, the number of edges, and the numerical values shown in FIGS. 8A-8C are examples. FIGS. 8A-8C may be described with reference to FIGS. 1, 2, 3, 7A and 7B, and redundant descriptions may be omitted.

The graphs shown in FIGS. 8A-8C may be graphs displayed on the display 230 of the second device 200. The graph shown in FIG. 8A may show a portion of the task dependency graph TDG generated by visualizing the log data LGD of FIG. 1.

In an embodiment, dependency information based on a wakeup signal transferred from a fifth node N5a to a third node N3a may be indicated through a first edge Ela. Dependency information based on a wakeup signal from the fifth node N5a to a second node N2a may be indicated through a second edge E2a. Dependency information based on a wakeup signal from a first node N1a to the third node N3a may be indicated through a third edge E3a. Dependency information based on a wakeup signal from the first node N1a to the second node N2a may be indicated through a fourth edge E4a. Dependency information based on a wakeup signal from the first node N1a to a fourth node N4a may be indicated through a fifth edge E5a.

FIG. 8B may be a diagram illustrating that scheduling information about a selected node is display. In particular, FIG. 8B may be a diagram illustrating that cluster information CLINF is displayed in the scheduling information.

In an embodiment, it is assumed that a user selects the first node N1 to look at a task corresponding to the first node N1, that is, cluster information about the first task. The selected node may mean a node selected by the user for task statistical information analysis. For example, when the user selects the first node N1, the first node N1 may be a selected node. When the user selects the first node N1, cluster information CLINF related to the first node N1 may be displayed. The cluster information CLINF may include information about which cluster the first task is assigned to and executed in the first processor 110 of the first device 100. For example, the cluster information CLINF shown in FIG. 8B may mean that the first task is assigned to a first cluster CL1 to be executed for 1.41 s, and a second cluster CL2, and may mean that the first task is not assigned to a second cluster CL2 to a fourth cluster CL4.

In an embodiment, the third, fourth, and fifth edges E3a, E4a, and E5a connected to the first node N1a, which is a selected node, may be displayed as thicker lines than the first and second edges Ela and E2a, which are not connected to the first node N1a.

FIG. 8C may be a diagram illustrating that scheduling information about a selected node is displayed. In particular, FIG. 8C may be a diagram illustrating that core information COINF is displayed in the scheduling information.

In an embodiment, it is assumed that a user selects the first node N1 to look at a task corresponding to the first node N1, that is, cluster information about the first task. The selected node may mean a node selected by the user for task statistical information analysis. For example, when the user selects the first node N1, the first node N1 may be a selected node. When he user selects the first node N1, core information COINF related to the first node N1 may be displayed. The core information COINF may include information about which core the first task is assigned to and executed in the first processor 110 of the first device 100. For example, the core information COINF shown in FIG. 8C may mean that the first task is assigned to a first core CO1 to be executed for 1.41 ms, and may mean that the first task is not assigned to a second core CO2 to an eighth core CO8.

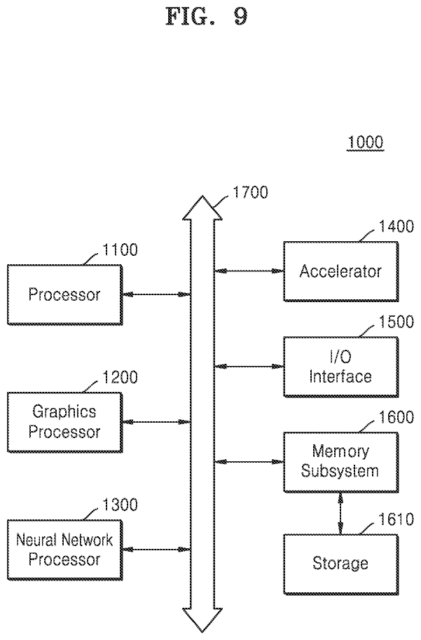

FIG. 9 is a block diagram illustrating a system according to one or more embodiments. In particular, a system 1000 of FIG. 9 may correspond to devices according to the embodiments of FIGS. 1 to 8C. FIG. 9 may be described with reference to FIG. 1, and redundant descriptions may be omitted.

As shown in FIG. 9, the system 1000 may include a processor 1100, a graphics processor 1200, a neural network processor 1300, an accelerator 1400, an input/output interface 1500, a memory subsystem 1600, a storage 1610, and a bus 1700. The processor 1100, the graphics processor 1200, the neural network processor 1300, the accelerator 1400, the input/output interface 1500, and the memory subsystem 1600 may communicate with each other through the bus 1700. In some embodiments, the system 1000 may be a system-on-chip (SoC) in which components are implemented on a single chip, and the storage 1610 may be external to the SoC. In some embodiments, at least one of the components shown in FIG. 8 may be omitted from the system 1000.

The processor 1100 may control an operation of the system 1000 at the highest layer, and may control other components of the system 1000. The processor 1100 may communicate with the memory subsystem 1600 and execute instructions. In some embodiments, the processor 1100 may execute a program stored in the memory subsystem 1600. A program may include a series of instructions. The processor 1100 may be any hardware capable of independently executing instructions, and may be referred to as an application processor (AP), a communication processor (CP), a CPU, a processor core, a core, or the like.

The graphics processor 1200 may execute instructions related to graphic processing, and may provide, to the memory subsystem 1600, data generated by processing data obtained from the memory subsystem 1600.

The neural network processor 1300 may be designed to process operations based on an artificial network at high speed, and may enable functions based on artificial intelligence (AI).

In some embodiments, the processor 1100, the graphics processor 1200, and the neural network processor 1300 may include two or more processing cores. As described above with reference to drawings, the processor 1100 may execute a method of controlling a shared resource access according to the disclosure.

The accelerator 1400 may be designed to perform designated functions at high speed. For example, the accelerator 1400 may provide, to the memory subsystem 1600, data generated by processing data obtained from the memory subsystem 1600.

The input/output interface 1500 may provide an interface for obtaining an input from the outside of the system 1000 and providing an output to the outside of the system 1000.

The memory subsystem 1600 may be accessed by other components connected to the bus 1700. In some embodiments, the memory subsystem 1600 may include volatile memory such as DRAM and SRAM, and may include non-volatile memory such as flash memory and resistive random access memory (RRAM). Also, in some embodiments, the memory subsystem 1600 may provide an interface for the storage 1610. The storage 1610 may be a storage medium that does not lose data even when power is cut off. For example, the storage 1610 may also include a semiconductor memory device such as non-volatile memory, or may also include any storage medium such as a magnetic card/disk or an optical card/disk. A task analysis method according to one or more embodiments may be stored in the memory subsystem 1600 or the storage 1610.

The memory subsystem 1600 may be accessed by the processor 1100, and may include software elements executable by the processor 1100. Non-limiting examples of a software element may include a software component, a program, an application, a computer program, an application program, a system program, a software development program, a machine program, OS software, middleware, firmware, a software module, a routine, a subroutine, a function, a method, a procedure, a software interface, an API, an instruction set, computing code, computer code, a code segment, a computer code segment, a word, a value, a symbol, or a combination of two or more thereof.

The bus 1700 may operate based on one of various bus protocols. The various bus protocols may include at least one of an advanced microcontroller bus architecture (AMBA) protocol, an universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a mobile industry processor interface (MIPI) protocol, and an universal flash storage (UFS) protocol.

While certain example embodiments of the disclosure have been particularly shown and described, it will be understood that various changes in form and details may be made therein without departing from the spirit and scope of the following claims and their equivalents.

What is claimed is:

1. A method to analyze tasks, the method comprising:
obtaining, by a second device from a first device, log data comprising a plurality of log entries corresponding to a plurality of tasks executed in the first device;
grouping the plurality of log entries into a plurality of groups based on at least one of task identifier information in each of the plurality of log entries and a type of each of the plurality of log entries;
determining execution information and dependency information corresponding to each of the plurality of tasks, based on summing values extracted from log entries in each of the plurality of groups; and
generating a task dependency graph indicating dependency information between the plurality of tasks and identifier information about each of the plurality of tasks, based on the execution information and the dependency information corresponding to each of the plurality of tasks.

2. The method of claim 1, wherein the task identifier information corresponding to each of the plurality of log entries comprises thread identifier information and process identifier information, and
wherein each of the plurality of log entries comprises information about a time when each log entry is generated.

3. The method of claim 2, wherein the log data comprises at least one of log entries comprising wakee task identifier information, and
wherein the grouping the plurality of log entries comprises:
grouping the plurality of log entries based on the thread identifier information and the process identifier information;
grouping the plurality of log entries based on the wakee task identifier information; and
sorting the grouped log entries based on a time when each log entry is generated for each group.

4. The method of claim 3, wherein the determining the execution information and the dependency information comprises:
determining, for each of the plurality of groups grouped by the thread identifier information and the process identifier information, a waker count, which is a number of wakeup signals transferred by a waker task, based on a number of log entries comprising the wakee task identifier information;
determining, for each of the plurality of groups grouped by the thread identifier information and the process identifier information, a wakee count, which is a number of wakeup signals received by a wakee task from a waker task, based on the wakee task identifier information in the plurality of log entries; and
determining dependency information between the waker task and the wakee task based on the waker count and the wakee count.

5. The method of claim 4, wherein the determining the execution information and the dependency information comprises filtering a task having dependency information less than a reference value.

6. The method of claim 2, wherein the generating the task dependency graph comprises grouping each of a plurality of nodes in the task dependency graph based on the process identifier information.

7. The method of claim 1, wherein the task dependency graph comprises:
a plurality of nodes respectively corresponding to the plurality of tasks; and
a plurality of edges indicating dependencies between the plurality of tasks.

8. The method of claim 7, wherein the generating of the task dependency graph comprises:
generating information about a selected node selected based on an input of a user, from among the plurality of nodes in the task dependency graph; and
displaying the generated information about the selected node and the task dependency graph, and
wherein the information about the selected node comprises at least one of information about a core processing a task corresponding to the selected node in the first device and information about a cluster.

9. A device comprising:
a memory storing at least one instruction;
at least one processor configured to execute the at least one instruction to:
obtain, from a host device, log data comprising a plurality of log entries corresponding to a plurality of tasks executed in the host device,
group the plurality of log entries into a plurality of groups based on at least one of task identifier information in each of the plurality of log entries and a type of each of the plurality of log entries,
determine execution information and dependency information corresponding to each of the plurality of tasks, based on summing values extracted from log entries in each of the plurality of groups, and
generate a task dependency graph indicating dependency information between the plurality of tasks and information about each task, based on the execution information and the dependency information corresponding to each of the plurality of tasks.

10. The device of claim 9, wherein the task identifier information corresponding to each of the plurality of log entries comprises thread identifier information and process identifier information, and
wherein each of the plurality of log entries comprises information about a time when each log entry is generated.

11. The device of claim 10, wherein the log data comprises at least one log entry comprising wakee task identifier information, and
wherein the at least one processor is further configured to execute the at least one instruction to:
group the plurality of log entries based on the thread identifier information and the process identifier information,
group the plurality of log entries based on the wakee task identifier information, and
sort the grouped log entries based on a time when each log entry is generated for each group.

12. The device of claim 11, wherein the at least one processor is further configured to execute the at least one instruction to:
determine, for each of the plurality of groups grouped by the thread identifier information and the process identifier information, a waker count, which is a number of wakeup signals transferred by a waker task, based on a number of log entries comprising the wakee task identifier information,
determine, for each of the plurality of groups grouped by the thread identifier information and the process identifier information, a wakee count, which is a number of wakeup signals received by a wakee task from a waker task, based on the wakee task identifier information in the plurality of log entries, and
determine dependency information between the waker task and the wakee task based on the waker count and the wakee count.

13. The device of claim 12, wherein the at least one processor is further configured to execute the at least one instruction to:
filter a task having dependency information less than a reference value when summing values corresponding to log information of the plurality of log entries for each group.

14. The device of claim 10, wherein the at least one processor is further configured to execute the at least one instruction to:
group each of a plurality of nodes in the task dependency graph based on the process identifier information.

15. The device of claim 9, wherein the task dependency graph comprises:
a plurality of nodes respectively corresponding to the plurality of tasks; and
a plurality of edges indicating dependencies between the plurality of tasks.

16. The device of claim 15, further comprising a display,
wherein the at least one processor is further configured to execute the at least one instruction to:
generate information about a selected node selected based on an input of a user from among the plurality of nodes in the task dependency graph, and
output the generated information about the selected node and the task dependency graph through the display, and
wherein the information about the selected node comprises at least one of information about a core processing a task corresponding to the selected node in the host device and information about a cluster.

17. A non-transitory computer readable medium for storing computer readable program code or instructions which are executable by a processor to perform a method comprising:
obtaining, from a host device, log data comprising a plurality of log entries corresponding to a plurality of tasks executed by the host device;
grouping the plurality of log entries into a plurality of groups based on at least one of task identifier information in each of the plurality of log entries and a type of each of the plurality of log entries;
determining execution information and dependency information corresponding to each of the plurality of tasks, based on summing values extracted from log entries in each of the plurality of groups; and
generating a task dependency graph indicating dependency information between the plurality of tasks and information about each of the plurality of tasks, based on the execution information and the dependency information corresponding to each of the plurality of tasks.

18. The non-transitory computer-readable storage medium of claim 17, wherein the task identifier information corresponding to each of the plurality of log entries comprises thread identifier information and process identifier information, and
each of the plurality of log entries comprises information about a time when each log entry is generated.

19. The non-transitory computer-readable storage medium of claim 18, wherein the log data comprises at least one of log entries comprising wakee task identifier information, and wherein the grouping the plurality of log entries comprises:
grouping the plurality of log entries based on the thread identifier information and the process identifier information;
grouping the plurality of log entries based on the wakee task identifier information; and
sorting the grouped log entries based on a time when each log entry is generated for each group.

20. The non-transitory computer-readable storage medium of claim 19, wherein the determining the execution information and the dependency information comprises:
determining, for each of the plurality of groups grouped by the thread identifier information and the process identifier information, a waker count, which is a number of wakeup signals transferred by a waker task, based on a number of log entries comprising the wakee task identifier information;
determining, for each of the plurality of groups grouped by the thread identifier information and the process identifier information, a wakee count, which is a number of wakeup signals received by a wakee task from a waker task, based on the wakee task identifier information in the plurality of log entries; and
determining dependency information between the waker task and the wakee task based on the waker count and the wakee count.
